(19) United States
(12) Patent Application Publication
(10) Pub. No.: US 2008/0070016 A1
(43) Pub. Date: Mar. 20, 2008

(54) Polyimide composite flexible board and its preparation

(75) Inventors: Kuen Yuan Hwang, Hsinchu (TW); An Pang Tu, Hsinchu (TW); Sheng Yen Wu, Hsinchu (TW); Te Yu Lin, Hsinchu (TW)

Correspondence Address: BIRCH STEWART KOLASCH & BIRCH, PO BOX 747, FALLS CHURCH, VA, 22040-0747, US

(73) Assignee: CHANG CHUN PLASTICS CO., LTD.

(21) Appl. No.: 11/657,096

(22) Filed: Jan. 24, 2007

(30) Foreign Application Priority Data
Sep. 18, 2006 (TW) 095134412

(51) Int. Cl. B32B 15/08; B05D 3/02; B32B 37/00; B29C 65/00

(52) U.S. Cl. 428/213; 428/458; 428/473.5; 428/335; 264/171.18; 264/85; 427/388.1; 427/409; 156/292

(57) ABSTRACT

The present invention relates to a polyimide composite flexible board and a process for preparing the same. The process comprises sequentially applying polyamic acids individually having a glass transition temperature of from 280 to 330° C. and from 190 to 280° C. after imidization on a metal foil, subsequently subjecting the polyamic acids to imidization into polyimide by heating, and then pressing the polyimide-containing metal foil with each other or with another metal foil under high temperature to produce a two-metal-side printed circuit flexible board.

According to the present invention, it can obtain a polyimide composite flexible board having an excellent mechanical property, high heat resistance, and excellent dimension stability without using an adhering agent.

### FIELD OF THE INVENTION

The present invention relates to polyimide composite flexible board and a process preparing the same.

### BACKGROUND OF THE INVENTION

Aromatic polyimide film has been widely used in various technical fields because it exhibits excellent high-temperature resistance, outstanding chemical properties, high insulation, and high mechanical strength. For example, aromatic polyimide film is advantageously used in the form of a composite sheet of successive aromatic polyimide film/metal film to produce a flexible printed circuit (FPC), a carrier tape of tape automated bonding (TAB), and a lead-on-chip (LOC) structural tape. Especially, the flexible printed circuit board is broadly applied to materials of laptops, consumer electronic products, and mobile communication equipments.

Heat resistant plastic film such as aromatic polyimide film has been extensively used to laminate with metal foils in the production of printed circuit board. Most known aromatic polyimide film laminated with the metal foils is generally produced by using a thermosetting adhesive to combine the aromatic polyimide film with the metal foils together. A two-side flexible circuit board is mainly produced by applying the thermosetting adhesive such as epoxy resin or acrylic-based resin to both sides of polyimide film, and then removing a solvent through an oven to make the adhesive become Stage-B which is an intermediate stage during the reaction of the thermosetting resin, and subsequently laminating the upper and lower sides of the polyimide film with copper foils or the metal foils through heating and pressing, and finally putting the polyimide-containing foil in a high temperature oven to conduct thermosetting to Stage-C which is a final stage during the reaction of the thermosetting resin.

Nevertheless, the thermosetting adhesive is commonly deficient in the heat resistance and can only keep its adhesion under the temperature not more than 200° C. Therefore, most known adhesive cannot be used to produce composite film that needs high temperature treatment, for example, a printed circuit flexible board that needs weld or needs to be used under high temperature. To achieve heat resistance and flam retardance as required, the thermosetting resin used is halogen-containing flame resistant and bromine-containing resin or halogen-free phosphorus-containing resin. However, the halogen-containing thermosetting resin can generate toxic dioxins during burning which seriously pollute environment. Furthermore, the flexible board laminated by the thermosetting resin adhesive has high coefficient of thermal expansion, poor heat resistance, and bad dimension stability.

To overcome the above disadvantages of the flexible board produced by the thermosetting adhesive, the present inventors apply various polyamic acids as polyimide precursors to a metal foil and then subject the polyamic acids to imidization by heating to obtain a halogen-free and phosphorus-free flexible board having high adhesion, high heat resistance, and excellent dimension stability. Thus the present invention is completed.

### BRIEF DESCRIPTION OF THE INVENTION

The first object of the present invention relates to a polyimide composite flexible board, which is made by sequentially laminating a metal foil, a first polyimide thin layer having a glass transition temperature of from 280 to 330° C., and a second polyimide thin layer having a glass transition temperature of from 190 to 280° C.

According to the first object, the polyimide composite flexible board is further laminated with each other through the polyimide faces to form a two metal sides polyimide composite flexible board.

According to the first object, the polyimide composite flexible board is further laminated with a metal foil to form a two metal sides polyimide composite flexible board.

The present invention also relates to a process for preparing a polyimide composite flexible board which comprises sequentially applying polyamic acids individually having a glass transition temperature (Tg) of from 280 to 330° C. and from 190 to 280° C. after imidization on a metal foil, subsequently subjecting the polyamic acids to imidization into polyimide by heating, and then pressing the polyimide-containing metal foil with each other or with another metal foil under high temperature to produce a polyimide resin-metal foil composite printed circuit flexible board.

According to the present invention, it can obtain a polyimide composite flexible board having an excellent mechanical property, high heat resistance, and excellent dimension stability without using an adhering agent.

According to the process for preparing the polyimide composite flexible board of the present invention, a metal foil such as a copper foil is firstly applied with a polyamic acid resin (a) having a high Tg after imidization in order to be a support layer and provide the metal foil with high adhesion and raise the Tg of the obtained polyimide composite flexible board, and then applied with a polyamic acid resin (b) having a lower Tg after imidization with an excellent mechanical property and high adhesion in order to advantage to produce a two-side flexible board through a high temperature pressing roller or through press and lamination. The process of the present invention can improve problems of high coefficient of thermal expansion when the thermosetting resin is used in the prior art and raise heat resistance and dimension stability.

The present invention thus provides a process for preparing a polyimide composite flexible board which comprises the steps of:
(a) applying the first polyamic acid resin having a glass transition temperature of from 280 to 330° C. after imidization on a metal foil, which is subsequently in an oven heated at a temperature of 90 to 140° C. and then of 150 to 200° C. to remove a solvent;
(b) taking out the metal foil that is applied with the first polyamic acid and has removed the solvent, following by applying the second polyamic acid resin having a glass transition temperature of from 190 to 280° C. after imidization on the first polyamic acid layer, which is subsequently in an oven heated at a temperature of 90 to 140° C. and then of 150 to 200° C. to remove a solvent;
(c) into a nitrogen gas oven putting the metal foil applied with polyamic acids, which is then sequentially heated at a temperature of 160 to 190° C., 190 to 240° C., 270 to 320° C. and 330 to 370° C. to subject the polyamic acids to imidization.

According to the process for preparing a polyimide composite flexible board, which further comprises the step of:
(d) laminating and pressing the polyimide composite flexible board produced in step (c) with each other through the polyimide faces under a temperature of from 320 to 370° C. and a pressure of from 10 to 200 Kgf by using a pressing machine or a roll calender to produce a two metal sides polyimide composite flexible board.

According to the process for preparing a polyimide composite flexible board, which further comprises the step of:
(d′) laminating and pressing the polyimide composite flexible board produced in step (c) through the polyimide face with another metal foil under a temperature of from 320 to 370° C. and a pressure of from 10 to 200 Kgf by using a pressing machine or a roll calender to produce a two metal sides polyimide composite flexible board.

The present invention thus provides a polyimide composite flexible board made by sequentially laminating a metal foil, a polyimide thin layer having a glass transition temperature of from 280 to 330° C., a polyimide thin layer having a glass transition temperature of from 190 to 280° C., a polyimide thin layer having a glass transition temperature of from 190 to 280° C., a polyimide thin layer having a glass transition temperature of from 280 to 330° C., and a metal foil.

The present invention thus further provides a polyimide composite flexible board made by sequentially laminating a metal foil, a polyimide thin layer having a glass transition temperature of from 280 to 330° C., a polyimide thin layer having a glass transition temperature of from 190 to 280° C., and a metal foil.

### BRIEF DESCRIPTION OF FIGURES

FIG. 1 is a flow chart illustrating a commercial production of two-side flexible printed circuit board pressed with metal foils.

FIG. 2 is a schematic view of application equipment used in the process of the present invention.

FIG. 3 is a schematic view of imidization equipment used in the process of the present invention.

FIG. 4 is a schematic view of pressing equipment used in the process of the present invention.

### DETAILED DESCRIPTION OF THE INVENTION

In the process for preparing the polyimide composite flexible board of the present invention, a polyamic acid resin is obtained by reacting diamine of the following formula (I),

H₂N—R₁—NH₂ (I)

[wherein R₁ is a covalent bond; phenylene (—Ph—); —Ph—X—Ph— wherein X represents a covalent bond, C₁₋₄ alkylene which may be substituted with a halogen(s), —O—Ph—O—, —O—, —CO—, —S—, —SO—, or —SO₂—; C₂₋₁₄ aliphatic hydrocarbon group; C₄₋₃₀ aliphatic cyclic hydrocarbon group; C₆₋₃₀ aromatic hydrocarbon group; or —Ph—O—R₂—O—Ph— wherein R₂ represents —Ph— or —Ph—X—Ph—, and X represents a covalent bond, C₁₋₄ alkylene which may be substituted with a halogen(s), —O—Ph—O—, —O—, —CO—, —S—, —SO—, or —SO₂—];
with dianhydride of the following formula (II),

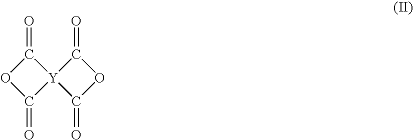

[wherein Y is a aliphatic group containing 2 to 12 carbon atoms; a cycloaliphatic group containing 4 to 8 carbon atoms; monocyclic or polycyclic C₆₋₁₄ aryl; >Ph—X—Ph< wherein X represents a covalent bond, C₁₋₄ alkylene which may be substituted with a halogen(s), —O—Ph—O—, —O—, —CO—, —S—, —SO—, or —SO₂—].

In the process for preparing the polyimide composite flexible board of the present invention, the first polyamic acid resin having a glass transition temperature of from 280 to 330° C. after imidization is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, preferably from 0.75 to 1.25, and the mole ratio of diamine monomer containing one benzene ring/other diamine monomer ranges from 20/80 to 60/40, and the mole ratio of dianhydride monomer containing one benzene ring/other dianhydride monomer ranges from 20/80 to 40/60.

In the process of the present invention, the second polyamic acid resin having a glass transition temperature of from 190 to 280° C. after imidization is obtained by reacting a diamine monomer containing at least two benzene rings and a dianhydride monomer containing two benzene rings with other dianhydride monomer, under the conditions that the mole ratio of total diamine monomer/total dianhydride monomer ranges from 0.5 to 2.0, preferably from 0.75 to 1.25, and the mole ratio of diamine monomer containing at least two benzene rings/other diamine monomer ranges from 60/40 to 100/0.

Embodiments of the dianhydride for preparing the polyamic acid in the present invention is for instance, but not limited to, aromatic dianhydride such as pyromellitic dianhydride (PMDA), 4,4′-oxydiphthalic anhydride (ODPA), 3,3′,4,4′-biphenyltetracarboxylic dianhydride (BPDA), 3,3′,4,4′-benzophenonetetracarboxylic dianhydride (BTDA), ethylenetetracarboxylic dianhydride, butanetetracarboxylic dianhydride, cyclopentanetetracarboxylic dianhydride, 2,2′,3,3′-benzophenonetetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy)diphthalic dianhydride, 4,4′-(m-phenylenedioxy)diphthalic dianhydride, 2,3,6,7-naphthalene-tetracarboxylic dianhydride, 1,4,5,8-naphthalenetetracarboxylic dianhydride, 1,2,5,6-naphthalenetetracarboxylic dianhydride, 1,2,3,4-benzene-tetracarboxylic dianhydride, 3,4,9,10-perylenetetracarboxylic dianhydride, 2,3,6,7-anthracenetetracarboxylic dianhydride, 1,2,7,8-phenanthrene-tetracarboxylic dianhydride, etc. The foregoing dianhydrides can be used alone or in combination of two or more. Among these, pyromellitic dianhydride (PMDA), 4,4′-oxydiphthalic anhydride (ODPA), 3,3′,4,4′-biphenyltetracarboxylic dianhydride (BPDA), and 3,3′,4,4′-benzophenonetetracarboxylic dianhydride (BTDA) are preferable.

Embodiments of the diamine for preparing the polyamic acid in the present invention is for instance, but not limited to, aromatic diamine such as p-phenylene diamine (PDA), 4,4-oxydianiline (ODA), 1,3-bis(4-aminophenoxy)benzene (TPE-R), 1,3-bis(3-aminophenoxy)benzene (APB), 2,2-bis[4-(4-aminophenoxy)phenyl]propane (BAPP), bis[4-(4-aminophenoxy)phenyl]sulfone (BAPS), 4,4′-bis(4-aminophenoxy)-3,3′-dihydroxybiphenyl (BAPB), bis[4-(3-aminophenoxy)phenyl]methane, 1,1-bis[4-(3-aminophenoxy)phenyl]ethane, 1,2-bis[4-(3-aminophenoxy)phenyl]ethane, 2,2-bis[4-(3-aminophenoxy)phenyl]propane, 2,2′-bis[4-(3-aminophenoxy)phenyl]butane, 2,2-bis[4-(3-aminophenoxy)phenyl]-1,1,1,3,3,3-hexafluoropropane, 4,4′-bis(3-aminophenoxy)-biphenyl, bis[4-(3-aminophenoxy)phenyl]ketone, bis[4-(3-aminophenoxy)phenyl]sulfide, bis[4-(3-aminophenoxy)phenyl]sulfoxide, bis[4-(3-aminophenoxy)phenyl]sulfone, bis[4-(3-aminophenoxy)phenyl]ether, etc. The foregoing diamines can be used alone or in combination of two or more. Among these, p-phenylene diamine (PDA), 4,4′-oxydianiline (ODA), 1,3-bis(4-aminophenoxy)benzene (TPE-R), 1,3-bis(3-aminophenoxy)benzene (APB), 2,2-bis[4-(4-aminophenoxy)phenyl]propane (BAPP), bis[4-(4-aminophenoxy)phenyl]sulfone (BAPS), and 4,4′-bis(4-aminophenoxy)-3,3′-dihydroxybiphenyl (BAPB) are preferable.

The dianhydrides can react with the diamines in aprotic polar solvents. The aprotic polar solvents are not particularly limited as long as they do not react with reactants and products. Embodiments of the aprotic polar solvents are for instance N,N-dimethylacetamide (DMAc), N-methylpyrrolidone (NMP), N,N-dimethylformamide (DMF), tetrahydrofuran (THF), dioxane, chloroform (CHCl₃), dichloromethane, etc. Among these, N-methylpyrrolidone (NMP) and N,N-dimethyl-acetamide (DMAc) are preferable.

The reaction of the dianhydrides and the diamines can be generally conducted in the range of from room temperature to 90° C., preferably from 30 to 75° C. Additionally, the mole ratio of aromatic diamines to aromatic dianhydrides ranges between 0.5 and 2.0, preferably between 0.75 and 1.25. When two or more dianhydrides and diamines are individually used to prepare the polyamic acids, their kinds are not particularly limited but depend on the final use of the polyimides as required.

Preferably, for the first polyamic acid having a glass transition temperature of from 280 to 330° C. after imidization, the used diamines at least include p-phenylene diamine (PDA) and the used dianhydrides at least include pyromellitic dianhydride (PMDA), under the conditions that the mole ratio of p-phenylene diamine monomer/other diamine monomer ranges from 20/80 to 60/40, and the mole ratio of pyromellitic dianhydride monomer/other dianhydride monomer ranges from 20/80 to 40/60.

Preferably, for the second polyamic acid having a glass transition temperature of from 190 to 280° C. after imidization, the used diamines include a diamine monomer containing at least two benzene rings which are selected from at least one group consisting of 2,2-bis[4-(4-aminophenoxy)phenyl]propane (BAPP), bis[4-(4-aminophenoxy)phenyl]sulfone (BAPS), 1,3-bis(3-aminophenoxy)benzene (APB), 4,4′-oxydianiline (ODA), and 4,4′-bis(4-aminophenoxy)-3,3′-dihydroxybiphenyl (BAPB), and the used dianhydrides include a dianhydride monomer containing two benzene rings which are selected from at least one group consisting of 4,4′-oxydiphthalic dianhydride (ODPA), 3,3′,4,4′-biphenyltetracarboxylic dianhydride (BPDA), and 3,3′,4,4′-benzophenonetetracarboxylic dianhydride (BTDA), under the conditions that the mole ratio of diamine monomer containing at least two benzene rings/other diamine monomer ranges from 60/40 to 100/0.

According to the polyimide composite flexible board and its preparation of the present invention, the thickness of the metal foil such as copper foil is not particularly limited but depends on the final use of the obtained composite flexible board. However, the thickness of the metal foil usually ranges from 12 μm to 70 μm. When the obtained polyimide composite flexible board consists of the metal foil/the first polyimide thin layer/the second polyimide thin layer/the second polyimide thin layer/the first polyimide thin layer/the metal foil, the thicknesses of the first polyimide thin layer and the second polyimide thin layer individually satisfy the following conditions.

$$70 / 100 \leq \frac{\begin{matrix}The Total Thickness of the Frist \\ Polyimide Thin Layers\end{matrix}}{\begin{matrix}The Total Thickness of Four \\ Layers of Polyimides\end{matrix}} \leq 90 / 100$$

$$10 / 100 \leq \frac{\begin{matrix}The Total Thickness of the Second \\ Polyimide Thin Layers\end{matrix}}{\begin{matrix}The Total Thickness of Four \\ Layers of Polyimides\end{matrix}} \leq 30 / 100$$

Moreover, when the obtained polyimide composite flexible board consists of the metal foil/the first polyimide thin layer/the second polyimide thin layer/the metal foil, the thicknesses of the first polyimide thin layer and the second polyimide thin layer individually satisfy the following conditions.

$$70 / 100 \leq \frac{\begin{matrix}The Thickness of the Frist \\ Polyimide Thin Layer\end{matrix}}{\begin{matrix}The Total Thickness of Two \\ Layers of Polyimides\end{matrix}} \leq 90 / 100$$

$$10 / 100 \leq \frac{\begin{matrix}The Thickness of the Second \\ Polyimide Thin Layer\end{matrix}}{\begin{matrix}The Total Thickness of Two \\ Layers of Polyimides\end{matrix}} \leq 30 / 100$$

The present invention will further illustrate by reference to the following synthesis examples and working examples. However, these synthesis examples and working examples are not intended to limit the scope of the present invention but only describe the present invention.

### EXAMPLES

### Synthesis Example

(a) Synthesis of Polyamic Acid (PAA) 1-1

Into a four-neck bottle reactor equipped with a stirrer and a nitrogen gas conduit under the flow rate of nitrogen gas of 20 cc/min, 5.4 g (0.05 mole) of p-phenylene diamine (PDA) was placed and dissolved in N-methylpyrrolidone (NMP). After 15 minutes, 10 g (0.05 mole) 4,4′-oxydianiline (ODA) was fed to dissolve and meantime maintained at a temperature of 15° C. 8.82 g (0.03 mole) of 3,3′,4,4′-biphenyltetracarboxylic dianhydride (BPDA) and 15 g of NMP were fed in the first flask accompanied with a stir bar and then stirred to dissolve. Subsequently, the mixture in the first flask was added to the above reactor that the nitrogen gas was continuously charged and stirred to carry out the reaction for one hour. 16.1 g (0.05 mole) of 3,3′,4,4′-benzophenonetetracarboxylic dianhydride (BTDA) and 30 g of NMP were fed in the second flask and then stirred to dissolve. Subsequently, the mixture in the second flask was added to the above reactor that the nitrogen gas was continuously charged and stirred to carry out the reaction for one hour. 4.36 g (0.02 mole) of pyromellitic dianhydride (PMDA) and 10 g of NMP were fed in the third flask and then stirred to dissolve. Subsequently, the mixture in the third flask was added to the above reactor that the nitrogen gas was continuously charged and stirred to carry out the reaction for one hour. Afterward, the reaction was carried out at a temperature of 15° C. for further four hours to obtain the Polyamic Acid (PAA) 1-1.

0.5 g of the obtained Polyamic Acid 1-1 dissolved in 100 ml of NMP, and at a temperature of 25° C., was measured the intrinsic viscosity (IV) as 0.85 dl/g and the glass transition temperature (Tg) after imidization as 290° C.

According to the ingredients and their amount listed in Table 1, Polyamic Acids 1-2 and 1-3 were synthesized by the analogous procedures and measured the intrinsic viscosity (IV) and the glass transition temperature (Tg) after imidization shown in Table 1 as well.

TABLE 1

| | PAA 1-1 | PAA 1-2 | PAA 1-3 |
|---|---|---|---|
| BPDA (mole) | 0.03 | 0.02 | 0.03 |
| BTDA (mole) | 0.05 | 0.06 | 0.05 |
| PMDA (mole) | 0.02 | 0.02 | 0.02 |
| PDA (mole) | 0.05 | 0.05 | 0.06 |
| ODA (mole) | 0.05 | 0.05 | 0.04 |
| Intrinsic | 0.85 | 0.93 | 0.97 |
| Viscosity (IV) | | | |
| (dl/g) | | | |
| Tg (° C.) | 290 | 285 | 297 |

(b) Synthesis of Polyamic Acid 2-1

Into a four-neck bottle reactor equipped with a stirrer and a nitrogen gas conduit under the flow rate of nitrogen gas of 20 cc/min, 41 g (0.1 mole) of 2,2-bis[4-(4-aminophenoxy)phenyl]propane (BAPP) was placed and dissolved in N-methylpyrrolidone (NMP). After 15 minutes, 2.94 g (0.01 mole) of 3,3′,4,4′-biphenyltetracarboxylic dianhydride (BPDA) and 15 g of NMP were fed in the first flask accompanied with a stir bar and then stirred to dissolve. Subsequently, the mixture in the first flask was added to the above reactor that the nitrogen gas was continuously charged and stirred to carry out the reaction for one hour. 22.54 g (0.07 mole) of 3,3′,4,4′-benzophenonetetracarboxylic dianhydride (BTDA) and 15 g of NMP were fed in the second flask and then stirred to dissolve. Subsequently, the mixture in the second flask was added to the above reactor that the nitrogen gas was continuously charged and stirred to carry out the reaction for one hour. 6.2 g (0.02 mole) of 4,4′-oxydiphthalic anhydride (ODPA) and 30 g of NMP were fed in the third flask and then stirred to dissolve. Subsequently, the mixture in the third flask was added to the above reactor that the nitrogen gas was continuously charged and stirred to carry out the reaction for one hour. Afterward, the reaction was carried out at a temperature of 15° C. for further four hours to obtain the polyamic acid 2-1.

0.5 g of the obtained polyamic acid 2-1 dissolved in 100 ml of NMP, and at a temperature of 25° C., was measured the intrinsic viscosity (IV) as 0.95 dl/g and the glass transition temperature (Tg) after imidization as 223° C.

According to the ingredients and their amount listed in Table 2, Polyamic Acids (PAA) 2-2, 2-3, 2-4, 2-5, 2-6, and 2-7 were synthesized by the analogous procedures and measured the intrinsic viscosity (IV) and the glass transition temperature (Tg) after imidization shown in Table 2 as well.

TABLE 2

| | | | | PAA | PAA | PAA | |
|---|---|---|---|---|---|---|---|
| | PAA 2-1 | PAA 2-2 | PAA 2-3 | 2-4 | 2-5 | 2-6 | PAA 2-7 |
| BPDA | 0.01 | 0.01 | 0.01 | 0.01 | 0.01 | 0.01 | 0.01 |
| BTDA | 0.07 | 0.07 | 0.07 | 0.07 | 0.07 | 0.07 | 0.07 |
| ODPA | 0.02 | 0.02 | 0.02 | 0.02 | | 0.02 | 0.02 |
| DSDA | | | | | 0.02 | | |
| ODA | | | | | | 0.02 | 0.01 |
| BAPP | 0.01 | | | | | 0.08 | 0.09 |
| BAPB | | 0.01 | | | | | |
| BAPS | | | 0.01 | | | | |
| TPE-R | | | | 0.01 | | | |
| APB | | | | | 0.01 | | |
| Intrinsic | 0.95 | 0.77 | 0.87 | 0.79 | 0.83 | 0.88 | 0.74 |
| Viscosity | | | | | | | |
| (IV) (dl/g) | | | | | | | |
| Tg (° C.) | 223 | 243 | 229 | 225 | 217 | 236 | 225 |

### In Table 2,

BPDA represents 3,3′,4,4′-biphenyltetracarboxylic dianhydride;
BTDA represents 3,3′,4,4′-benzophenonetetracarboxylic dianhydride;
ODPA represents 4,4′-oxydiphthalic anhydride;
DSDA represents 3,3′,4,4′-diphenylsulfonetetracarboxylic dianhydride;
ODA represents 4,4′-oxydianiline;
BAPP represents 2,2-bis[4-(4-aminophenoxy)phenyl]propane;
BAPB represents 4,4′-bis(4-aminophenoxy)-3,3′-dihydroxybiphenyl;
BAPS represents bis[4-(4-aminophenoxy)phenyl]sulfone;
TPE-R represents 1,3-bis(4-aminophenoxy)benzene; and
APB represents 1,3-bis(3-aminophenoxy)benzene.

### Working Examples 1 to 11 and Comparative Examples 1 to 5

According to ingredients listed in Table 3 and Table 4, the polyamic acid resin 1 obtained from the above synthesis examples was evenly applied on a copper foil with the thickness of 18 μm by a wire rod, and the thickness of the applied polyamic acid resin 1 was 9 μm. Into an oven, the copper foil was heated at a temperature of 120° C. for 3 minutes and 180° C. for 5 minutes to remove a solvent. The dried copper foil applied with the polyamic acid 1 was taken out on which the polyamic acid resin 2 was then applied with the thickness of 3 μm. Subsequently, into an oven, the copper foil was heated at a temperature of 120° C. for 3 minutes and 180° C. for 7 minutes to remove a solvent. The obtained copper foil was put into a nitrogen gas oven at a temperature of 180° C. for 1 hour, 220° C. for 1 hour, 300° C. for 0.6 hour, and 350° C. for 0.5 hour to subject the polyamic acids to imidization reaction. After cooling, the polyimide-containing copper foil was taken out and pressed with another polyimide-containing copper foil through the polyimide faces or pressed with another copper foil under a temperature of 340° C. and a pressure of 100 Kgf by using a flat pressing machine in batch or a roll calendar in continuity to produce a two-side copper-foil-pressed flexible printed circuit board. The structure of the composite flexible board having six layers of polyimides was copper foil/polyimide 1 (280° C.<Tg<330° C.)/polyimide 2 (190° C.<Tg<280° C.)/polyimide 2 (190° C.<Tg<280° C.)/polyimide 1 (280° C.<Tg<330° C. )/copper foil, and the structure of the composite flexible board having four layers of polyimides was copper foil/polyimide 1 (280° C.<Tg<330° C.)/polyimide 2 (190° C.<Tg<280° C. )/copper foil.

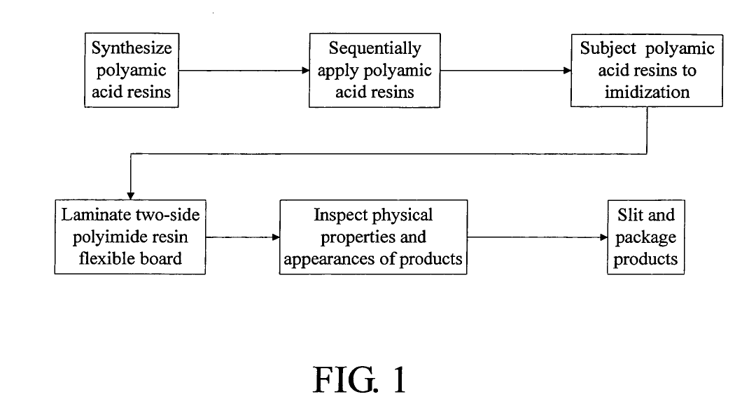

Generally, the two-side copper-foil-pressed flexible printed circuit board could be produced as a procedure shown in FIG. 1. Various polyamic acid resins were synthesized, sequentially applied, and subjected to imidization into polyimide. Afterwards, the polyimide resin-containing flexible board was laminated with a copper foil by pressing. The flexible board was subsequently inspected physical properties and appearances and then slit and packaged.

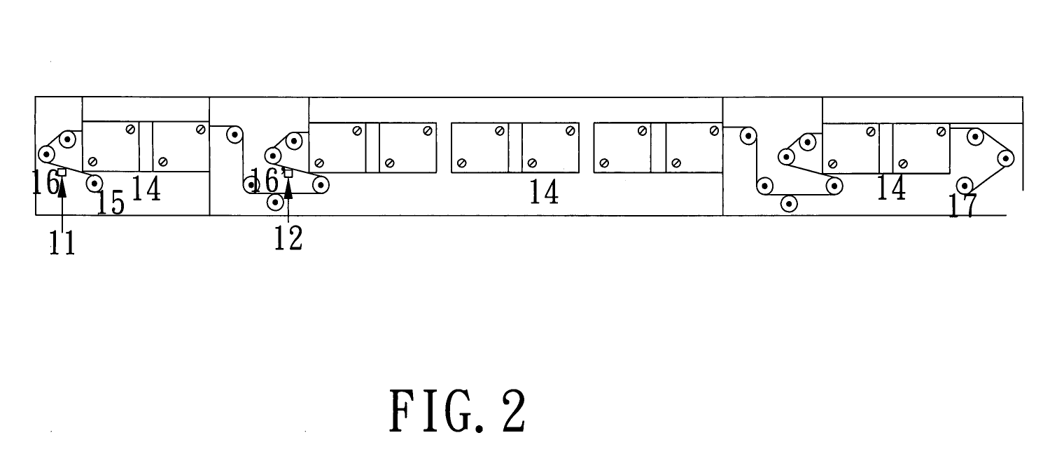

The foregoing flexible board could be produced by using equipments shown in FIG. 2 to FIG. 4. Firstly, the polyamic acid resins were applied by utilizing the application equipment shown in FIG. 2. The copper foil was delivered to the application equipment by a feeding roller 15; applied with polyamic acid resin 1 at location 11 by an applicator tip 16 and passed through an oven 14 to conduct the first stage of heating and removing a solvent; then applied with polyamic acid resin 2 at location 12 by an applicator tip 16′ and passed through an oven 14′ to conduct the second stage of heating and removing a solvent; and collected on the other side by a collect roller 17. The copper foil roll applied with two layers of various polyamic acid resins was obtained.

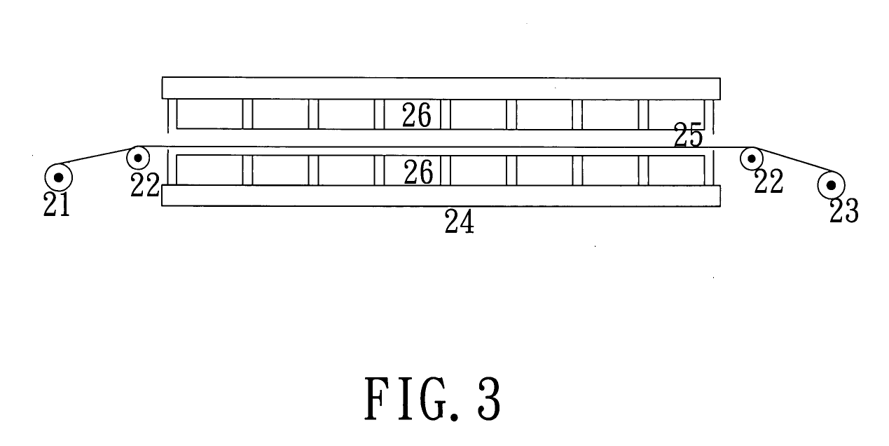

Subsequently, the imidization equipment shown in FIG. 3 was utilized. The foregoing copper foil roll was put on a feeding roller 21; introduced and passed through an oven 24 and a nitrogen gas oven 25 by directive rollers 22, 22 that were individually installed at the inlet and the outlet of the oven 24; subjected to imidization by a heating apparatus 26; and collected on the other side by a collect roller 23. The copper foil roll having two layers of various polyimides was obtained.

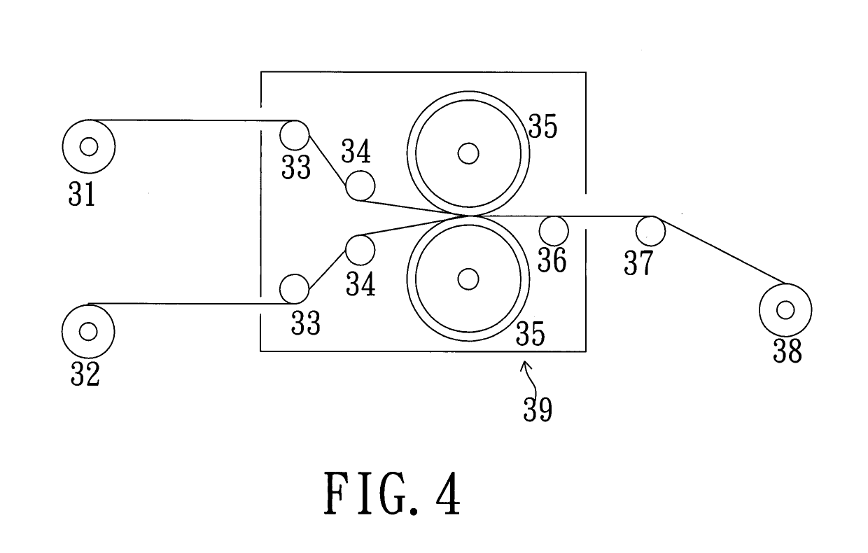

Finally, the pressing equipment shown in FIG. 4 was utilized. The above obtained copper foil roll having two layers of various polyimides was put on a feeding roller 32, and meanwhile another copper foil roll having two layers of various polyimides or another copper foil roll only was put on another feeding roller 31. Both copper foil rolls were introduced and passed through a high temperature pressing roller 35 by individual guide rollers 33 and 34; pressed to produce a copper foil roll having two-side copper; and collected at a collect roller 38 through guide rollers 36 and 37. The guide rollers 33, 34 and 36 and the high temperature pressing roller 35 were placed into a nitrogen gas oven 39.

The resultant copper foil was measured the peel strength according to IPC-TM650 2.2.9, the coefficient of thermal expansion by thermal gravity analyzer, and dimension stability according to IPC-TM650 2.2.4. The results were shown in Tables 3 and 4.

TABLE 3

| | Working Example Number | | | | | | | | | | |
|---|---|---|---|---|---|---|---|---|---|---|---|
| | 1 | 2 | 3 | 4 | 5 | 6 | 7 | 8 | 9 | 10 | 11 |
| Metal Foil | A | A | A | B | C | A | A | A | A | A | A |
| (Copper Foil) | | | | | | | | | | | |
| 1^{st} Layer | Polyamic | Polyamic | Polyamic | Polyamic | Polyamic | Polyamic | Polyamic | Polyamic | Polyamic | Polyamic | Polyamic |
| (Bottom Layer) | Acid | Acid | Acid | Acid | Acid | Acid | Acid | Acid | Acid | Acid | Acid 1-1 |
| of Polyimide | 1-1 | 1-2 | 1-3 | 1-1 | 1-1 | 1-1 | 1-1 | 1-1 | 1-1 | 1-1 | |
| (Kind) | | | | | | | | | | | |
| 1^{st} Layer | 9 μm | 9 μm | 9 μm | 9 μm | 9 μm | 9 μm | 9 μm | 9 μm | 9 μm | 9 μm | 22 μm |
| (Bottom Layer) | | | | | | | | | | | |
| of Polyimide | | | | | | | | | | | |
| (Thickness) | | | | | | | | | | | |
| 2^{nd} Layer | Polyamic | Polyamic | Polyamic | Polyamic | Polyamic | Polyamic | Polyamic | Polyamic | Polyamic | Polyamic | Polyamic |
| (Adhesive Layer) | Acid | Acid | Acid | Acid | Acid | Acid | Acid | Acid | Acid | Acid | Acid 2-5 |
| of Polyimide | 2-1 | 2-1 | 2-1 | 2-2 | 2-3 | 2-4 | 2-5 | 2-2 | 2-3 | 2-4 | |
| (Kind) | | | | | | | | | | | |
| 2^{nd} Layer | 3 μm | 3 μm | 3 μm | 3 μm | 3 μm | 3 μm | 3 μm | 3 μm | 3 μm | 3 μm | 3 μm |
| (Adhesive Layer) | | | | | | | | | | | |
| of Polyimide | | | | | | | | | | | |
| (Thickness) | | | | | | | | | | | |
| 3^{rd} Layer | Polyamic | Polyamic | Polyamic | Polyamic | Polyamic | Polyamic | Polyamic | Polyamic | Polyamic | Polyamic | — |
| (Adhesive Layer) | Acid | Acid | Acid | Acid | Acid | Acid | Acid | Acid | Acid | Acid | |
| of Polyimide | 2-1 | 2-1 | 2-1 | 2-2 | 2-3 | 2-4 | 2-5 | 2-3 | 2-4 | 2-5 | |
| (Kind) | | | | | | | | | | | |
| 3^{rd} Layer | 3 μm | 3 μm | 3 μm | 3 μm | 3 μm | 3 μm | 3 μm | 3 μm | 3 μm | 3 μm | — |
| (Adhesive Layer) | | | | | | | | | | | |
| of Polyimide | | | | | | | | | | | |
| (Thickness) | | | | | | | | | | | |
| 4^{th} Layer | Polyamic | Polyamic | Polyamic | Polyamic | Polyamic | Polyamic | Polyamic | Polyamic | Polyamic | Polyamic | — |
| (Bottom Layer) | Acid | Acid | Acid | Acid | Acid | Acid | Acid | Acid | Acid | Acid | |
| of Polyimide | 1-1 | 1-2 | 1-3 | 1-1 | 1-1 | 1-1 | 1-1 | 1-1 | 1-2 | 1-3 | |
| (Kind) | | | | | | | | | | | |
| 4^{th} Layer | 9 μm | 9 μm | 9 μm | 9 μm | 9 μm | 9 μm | 9 μm | 9 μm | 9 μm | 9 μm | — |
| (Bottom Layer) | | | | | | | | | | | |
| of Polyimide | | | | | | | | | | | |
| (Thickness) | | | | | | | | | | | |
| Metal Foil | A | A | A | B | C | A | A | A | A | A | A |
| (Copper Foil) | | | | | | | | | | | |
| Whether | No | No | No | No | No | No | No | No | No | No | No |
| Adhesive | | | | | | | | | | | |
| Layers Separate | | | | | | | | | | | |
| Peel Strength | 1.3 | 1.2 | 1.2 | 1.1 | 1.5 | 1.3 | 1.1 | 1.2 | 1.1 | 1.3 | 1.2 |
| (kgf/cm) | | | | | | | | | | | |
| Applied Side | | | | | | | | | | | |
| Peel Strength | 1.2 | 1.1 | 1.2 | 1.1 | 1.4 | 1.3 | 1.3 | 1.2 | 1.2 | 1.4 | 1.2 |
| (kgf/cm) | | | | | | | | | | | |
| Pressed Side | | | | | | | | | | | |
| Dimension | −0.05 | −0.06 | −0.07 | −0.05 | −0.06 | −0.04 | −0.05 | −0.07 | −0.06 | −0.06 | −0.04 |
| stability (%, MD) | | | | | | | | | | | |
| Dimension | −0.05 | −0.05 | −0.08 | −0.06 | −0.05 | −0.06 | −0.06 | −0.05 | −0.05 | −0.05 | −0.05 |
| stability (%, TD) | | | | | | | | | | | |

Copper Foil A: Electrolytic copper foil ⅓ OZ ED manufactured by Chang Chun Plastic Co., Ltd., Taiwan, R.O.C.
Copper Foil B: Electrolytic copper foil ⅓ OZ ED manufactured by Furukawa Electric Co., Ltd., Japan.
Copper Foil C: Rolled copper foil ½ OZ ED manufactured by JE Co. Ltd.

TABLE 4

| | Comparative Example Number | | | | |
|---|---|---|---|---|---|
| | 1 | 2 | 3 | 4 | 5 |
| Metal Foil (Copper Foil) | A | A | A | A | A |
| 1^{st} Layer (Bottom | Polyamic Acid | Polyamic | Polyamic | Polyamic | Polyamic |
| Layer) of Polyimide | 1-1 | Acid 2-1 | Acid 2-2 | Acid 2-1 | Acid 2-4 |
| (Kind) | | | | | |
| 1^{st} Layer (Bottom | 25 μm | 25 μm | 9 μm | 9 μm | 3 μm |
| Layer) of Polyimide | | | | | |
| (Thickness) | | | | | |
| 2^{nd} Layer (Adhesive | | | Polyamic | Polyamic | Polyamic |
| Layer) of Polyimide | | | Acid 1-1 | Acid 1-2 | Acid 1-1 |
| (Kind) | | | | | |
| 2^{nd} Layer (Adhesive | | | 3 μm | 3 μm | 22 μm |
| Layer) of Polyimide | | | | | |
| (Thickness) | | | | | |
| 3^{rd} Layer (Adhesive | | | Polyamic | Polyamic | |
| Layer) of Polyimide | | | Acid 1-1 | Acid 1-2 | |
| (Kind) | | | | | |
| 3^{rd} Layer (Adhesive | | | 3 μm | 3 μm | |
| Layer) of Polyimide | | | | | |
| (Thickness) | | | | | |
| 4^{th} Layer (Bottom | | | Polyamic | Polyamic | |
| Layer) of Polyimide | | | Acid 2-2 | Acid 2-3 | |
| (Kind) | | | | | |
| 4^{th} Layer (Bottom | | | 9 μm | 9 μm | |
| Layer) of Polyimide | | | | | |
| (Thickness) | | | | | |
| Metal Foil (Copper | A | A | A | A | A |
| Foil) | | | | | |
| Peel Strength | 1.2 | 1.7 | 1.5 | 1.4 | 1.5 |
| (kgf/cm) | | | | | |
| Applied Side | | | | | |
| Peel Strength | 0.2 | 1.6 | 1.6 | 1.3 | 0.2 |
| (kgf/cm) | | | | | |
| Pressed Side | | | | | |
| Whether Adhesive | No | No | Yes | Yes | No |
| Layers Separate | | | | | |
| Dimension stability | −0.05 | −0.25 | −0.15 | −0.14 | −0.06 |
| (%, MD) | | | | | |
| Dimension stability | −0.03 | −0.23 | −0.17 | −0.13 | −0.05 |
| (%, TD) | | | | | |

Copper Foil A: Electrolytic copper foil ⅓ OZ ED manufactured by Chang Chun Plastic Co., Ltd., Taiwan, R.O.C.

According to the present invention, the polyamic acid resins individually having different glass transition temperature (Tg) after imidization were utilized. The polyamic acid resin having Tg of from 280 to 330° C. after imidization with high adhesion was firstly applied on the copper foil as a support layer, and then the polyamic acid resin having Tg of from 190 to 280° C. after imidization with an excellent mechanical property and adhesion was applied. Subsequently, the polyamic acids conducted imidization reaction. At the same time, the polyimide-containing copper foil was pressed with another polyimide-containing copper foil through the polyimide faces or pressed with another copper foil by using a high temperature roller or a pressing machine. A two-side printed circuit flexible board with heat stability and dimension stability could be thus obtained.

What is claimed is:

1. A polyimide composite flexible board, which is made by sequentially laminating a metal foil, a first polyimide thin layer having a glass transition temperature of from 280 to 330° C., and a second polyimide thin layer having a glass transition temperature of from 190 to 280° C.

2. The polyimide composite flexible board according to claim 1, wherein said first polyimide having a glass transition temperature of from 280 to 330° C. is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, and the mole ratio of diamine monomer containing one benzene ring/other diamine monomer ranges from 60/40 to 20/80, and the mole ratio of dianhydride monomer containing one benzene ring/other dianhydride monomer ranges from 40/60 to 20/80.

3. The polyimide composite flexible board according to claim 1, wherein said second polyimide having a glass transition temperature of from 190 to 280° C. is obtained by reacting a diamine monomer containing at least two benzene rings and a dianhydride monomer containing two benzene rings with other dianhydride monomer, under the conditions that the mole ratio of total diamine monomer/total dianhydride monomer ranges from 0.5 to 2.0, and the mole ratio of diamine monomer containing at least two benzene rings/other diamine monomer ranges from 60/40 to 100/0.

4. The polyimide composite flexible board according to claim 1, wherein the thickness of said metal foil ranges from 12 μm to 70 μm.

5. The polyimide composite flexible board according to claim 4, wherein said metal foil is a copper foil.

6. The polyimide composite flexible board according to claim 1, wherein the thicknesses of said first polyimide thin layer and said second polyimide thin layer individually satisfy the following conditions,
$$70 / 100 \leq \frac{\begin{matrix}The Thickness of said Frist \\ Polyimide Thin Layer\end{matrix}}{\begin{matrix}The Total Thickness of Two \\ Layers of Polyimides\end{matrix}} \leq 90 / 100$$
$$10 / 100 \leq \frac{\begin{matrix}The Thickness of said Second \\ Polyimide Thin Layer\end{matrix}}{\begin{matrix}The Total Thickness of Two \\ Layers of Polyimides\end{matrix}} \leq 30 / 100.$$

7. The polyimide composite flexible board according to claim 1, which is further laminated with a metal foil.

8. The polyimide composite flexible board according to claim 1, which is further laminated with each other through the polyimide faces.

9. The polyimide composite flexible board according to claim 8, wherein the thicknesses of said first polyimide thin layer and said second polyimide thin layer individually satisfy the following conditions,
$$70 / 100 \leq \frac{\begin{matrix}The Total Thickness of said Frist \\ Polyimide Thin Layers\end{matrix}}{\begin{matrix}The Total Thickness of Four \\ Layers of Polyimides\end{matrix}} \leq 90 / 100$$
$$10 / 100 \leq \frac{\begin{matrix}The Total Thickness of said Second \\ Polyimide Thin Layers\end{matrix}}{\begin{matrix}The Total Thickness of Four \\ Layers of Polyimides\end{matrix}} \leq 30 / 100$$

10. A process for preparing a polyimide composite flexible board, which comprises the following steps:
(a) applying the first polyamic acid resin having a glass transition temperature of from 280 to 330° C. after imidization on a metal foil, which is subsequently in an oven heated at a temperature of 90 to 140° C. and then of 150 to 200° C. to remove a solvent;
(b) taking out the metal foil that is applied with the first polyamic acid and has removed the solvent, following by applying the second polyamic acid resin having a glass transition temperature of from 190 to 280° C. after imidization on the first polyamic acid layer, which is subsequently in an oven heated at a temperature of 90 to 140° C. and then of 150 to 200° C. to remove a solvent;
(c) into a nitrogen gas oven putting the metal foil applied with polyamic acids, which is then sequentially heated at a temperature of 160 to 190° C., 190 to 240° C., 270 to 320° C. and 330 to 370° C. to subject the polyamic acids to imidization.

11. The process according claim 10, wherein said polyamic acid resin is obtained by reacting diamine of the following formula (I),
H₂N—R₁—NH₂ (I)
[wherein R₁ is a covalent bond; phenylene (—Ph—); —Ph—X—Ph— (wherein X represents a covalent bond; C₁₋₄ alkylene which may be substituted with a halogen(s); —O—Ph—O—; —O—; —CO—; —S—; —SO—; or —SO₂—); C₂₋₁₄ aliphatic hydrocarbon group; C₄₋₃₀ aliphatic cyclic hydrocarbon group; C₆₋₃₀ aromatic hydrocarbon group; or —Ph—O—R₂—O—Ph— wherein R₂ represents —Ph— or —Ph—X—Ph— (wherein X represents a covalent bond; C₁₋₄ alkylene which may be substituted with a halogen(s); —O—Ph—O—; —O—; —CO—; —S—; —SO—; or —SO₂—)];
with dianhydride of the following formula (II), 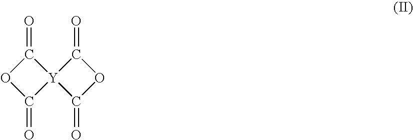
[wherein Y is a aliphatic group containing 2 to 12 carbon atoms; a cycloaliphatic group containing 4 to 8 carbon atoms; monocyclic or polycyclic C₆₋₁₄ aryl; >Ph—X—Ph< (wherein X represents a covalent bond; C₁₋₄ alkylene which may be substituted for a halogen(s);
—O—Ph—O—; —O—; —CO—; —S—; —SO—; or —SO₂—)].

12. The process according claim 10, wherein said first polyamic acid resin having a glass transition temperature of from 280 to 330° C. after imidization is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, and the mole ratio of diamine monomer containing one benzene ring/other diamine monomer ranges from 60/40 to 20/80, and the mole ratio of dianhydride monomer containing one benzene ring/other dianhydride monomer ranges from 40/60 to 20/80.

13. The process according claim 10, wherein said second polyamic acid resin having a glass transition temperature of from 190 to 280° C. after imidization is obtained by reacting a diamine monomer containing at least two benzene rings and a dianhydride monomer containing two benzene rings with other dianhydride monomer, under the conditions that the mole ratio of total diamine monomer/total dianhydride monomer ranges from 0.5 to 2.0, and the mole ratio of diamine monomer containing at least two benzene rings/other diamine monomer ranges from 60/40 to 100/0.

14. The process according claim 10, wherein the thickness of said metal foil ranges from 12 μm to 70 μm.

15. The process according claim 10, wherein said metal foil is a copper foil.

16. The process for preparing a polyimide composite flexible board of claim 10, which further comprises the step of:
(d) laminating and pressing the polyimide composite flexible board produced in step (c) with each other through the polyimide faces under a temperature of from 320 to 370° C. and a pressure of from 10 to 200 Kgf by using a pressing machine or a roll calender to produce a two metal sides polyimide composite flexible board.

17. The process for preparing a polyimide composite flexible board of claim 10, which further comprises the step of:
(d′) laminating and pressing the polyimide composite flexible board produced in step (c) through the polyimide face with another metal foil under a temperature of from 320 to 370° C. and a pressure of from 10 to 200 Kgf by using a pressing machine or a roll calender to produce a two metal sides polyimide composite flexible board.

18. The process according claim 16, wherein after said first polyamic acid resin and said second polyamic acid resin are subjected to imidization, the thicknesses of the first polyimide thin layer and the second polyimide thin layer individually satisfy the following conditions.
$$70 / 100 \leq \frac{\begin{matrix}The Total Thickness of the Frist \\ Polyimide Thin Layers\end{matrix}}{\begin{matrix}The Total Thickness of Four \\ Layers of Polyimides\end{matrix}} \leq 90 / 100$$
$$10 / 100 \leq \frac{\begin{matrix}The Total Thickness of the Second \\ Polyimide Thin Layers\end{matrix}}{\begin{matrix}The Total Thickness of Four \\ Layers of Polyimides\end{matrix}} \leq 30 / 100$$

19. The process according claim 17, wherein after said first polyamic acid resin and said second polyamic acid resin are subjected to imidization, the thicknesses of the first polyimide thin layer and the second polyimide thin layer individually satisfy the following conditions,
$$70 / 100 \leq \frac{\begin{matrix}The Thickness of the Frist \\ Polyimide Thin Layer\end{matrix}}{\begin{matrix}The Total Thickness of Two \\ Layers of Polyimides\end{matrix}} \leq 90 / 100$$
$$10 / 100 \leq \frac{\begin{matrix}The Thickness of the Second \\ Polyimide Thin Layer\end{matrix}}{\begin{matrix}The Total Thickness of Two \\ Layers of Polyimides\end{matrix}} \leq 30 / 100.$$
